(19) United States
(12) Patent Application Publication
(10) Pub. No.: US 2026/0022794 A1
(43) Pub. Date: Jan. 22, 2026

(54) SEAL

(71) Applicant: Craig M. Joyce, Auburn, NH (US)

(72) Inventor: Craig M. Joyce, Auburn, NH (US)

(21) Appl. No.: 18/774,396

(22) Filed: Jul. 16, 2024

(51) Int. Cl. F16L 59/16; F16L 59/153; F24F 1/0068

(52) U.S. Cl. CPC F16L 59/166; F16L 59/153; F24F 1/0068

(57) ABSTRACT

A line set seal comprising a pipe sealing end and an insulation sealing end, wherein the insulation sealing end is larger than the pipe sealing end, wherein the pipe sealing end is configured to seal to a pipe, and wherein the insulation sealing end is configured to seal to insulation.

### FIELD OF THE DISCLOSURE

The following disclosure relates generally to sealing, and, more specifically, to sealing insulation and pipes against moisture.

### BACKGROUND

Heating, Ventilation, and Air Conditioning (HVAC) systems come in one of two major varieties, ducted and ductless. While traditional HVAC systems have utilized ductwork to convey heated and/or cooled air around a premises, ductless HVAC systems do away with the ductwork and rely on a single point of ingress for the conditioned air, which is typically wall-mounted. In other respects, ductless mini-split systems are very similar to central air conditioning systems in that they have indoor and outdoor units, such as that depicted in FIG. 1, that rely on a compressor, condensing coil, and fan to condition a home's air.

The ductless market has grown significantly in the U.S. in the last 20 years. What was once a fringe product, used only for apartments and converted buildings lacking central air, has become a prominent subset of the HVAC world. This is, in part, because mini-splits are more energy efficient and quieter than traditional air conditioning systems since the introduction of the inverter-based compressor while also being much easier to install, especially in existing construction, such as during a remodel.

Since the introduction of mini-split inverter systems, however, the primary point of failure has always been the copper line sets, such as that depicted in FIG. 2, which are used to convey refrigerant between a compressor, such as that depicted in FIG. 1, and condensing coil. Insulating these line sets, which improves efficiency while also providing soundproofing and protection from moisture buildup due to condensation and other environmental factors, is essential to the efficiency of any air conditioning system, but also contributes to this very problem by trapping moisture against the line set, which inevitably results in accelerated corrosion.

More specifically, while insulation is necessary to allow the system to operate efficiently, gaps between this insulation and the copper line sets allows for moisture intrusion over time, which begins to break down the line sets through oxidation. This moisture intrusion also breaks down the insulation itself, making it even more susceptible to future moisture intrusion. This cycle results in premature failure of the system, which is typically replaced as a unit.

While manufacturers of line sets and insulation have incorporated sun and moisture resistant external coatings in an effort to prevent such failures, installers frequently cut line sets to length, inadvertently exposing unprotected material and speeding up the degradation process.

FIG. 1 provides an example of an insulation failure, with the compromised line set insulation called out by reference number 102. The time that it takes for this condition to develop and result in a failure depends on the location and quality of the installation.

When a failure occurs, the refrigerant, which tends to be a greenhouse gas and/or is damaging to the ozone layer, is released. Furthermore, future generations of refrigerants are expected to be flammable and designed to run at higher pressures, potentially increasing failure rates and the immediate danger posed by such failures.

Additionally, according to the EPA over 1,300 people die annually from heat exhaustion, many elderly and at least some due to failed air conditioning systems, many of which failed due to compromised line sets.

What is needed, therefore, is an apparatus and/or method of sealing insulation to a copper line set that mitigates the risk of moisture intrusion and increases the reliability and service life of a connected system.

### SUMMARY

The present disclosure provides a seal that slides over or is otherwise attached to each pipe in a copper line set and seals insulation disposed on each pipe to the pipe itself. By locking into place over the copper and insulation, the seal restricts water from entering that space and thereby prolongs the life of the line set and avoids this common mode of system failure.

Implementations of the techniques discussed above may include a method or process, a system or apparatus, a kit, or a computer software stored on a computer-accessible medium. The details or one or more implementations are set forth in the accompanying drawings and the description below. Other features will be apparent from the description and drawings, and form the claims.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a depiction of an outdoor HVAC compressor unit and line set demonstrating a defect common in such systems;

FIG. 2 is a line set for use in HVAC installations that includes insulation disposed thereon;

FIG. 3 is a line set including a seal configured to seal insulation to the line set tubing, in accordance with embodiments of the present disclosure;

FIG. 4 is a schematic showing a seal, in accordance with embodiments of the present disclosure;

FIG. 5 is an isometric view of a seal, in accordance with embodiments of the present disclosure;

FIG. 6 is an isometric view of a seal, in accordance with embodiments of the present disclosure;

FIG. 7 is an isometric view of a seal, in accordance with embodiments of the present disclosure;

FIG. 8 is an isometric view of a seal showing its internal structure, in accordance with embodiments of the present disclosure;

FIG. 9 is a front elevation view of a seal, in accordance with embodiments of the present disclosure;

FIG. 10 is a rear elevation view of a seal, in accordance with embodiments of the present disclosure;

FIG. 11 is a top elevation view of a seal, in accordance with embodiments of the present disclosure;

FIG. 12 is a bottom elevation view of a seal, in accordance with embodiments of the present disclosure;

FIG. 13 is a side elevation view of a seal, in accordance with embodiments of the present disclosure;

FIG. 14 is a 3D view of an embodiment of a seal, in accordance with embodiments of the present disclosure;

FIG. 15 is a front elevation view of an embodiment of a seal, in accordance with embodiments of the present disclosure;

FIG. 16 is a rear elevation view of an embodiment of a seal, in accordance with embodiments of the present disclosure;

FIG. 17 is a left-side elevation view of an embodiment of a seal, in accordance with embodiments of the present disclosure;

FIG. 18 is a right-side elevation view of an embodiment of a seal, in accordance with embodiments of the present disclosure;

FIG. 19 is a top plan view of an embodiment of a seal, in accordance with embodiments of the present disclosure; and

FIG. 20 is a bottom plan view of an embodiment of a seal, in accordance with embodiments of the present disclosure.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

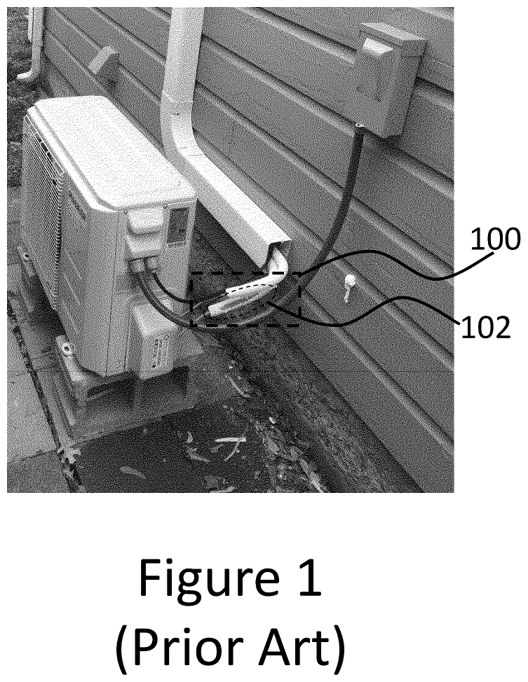

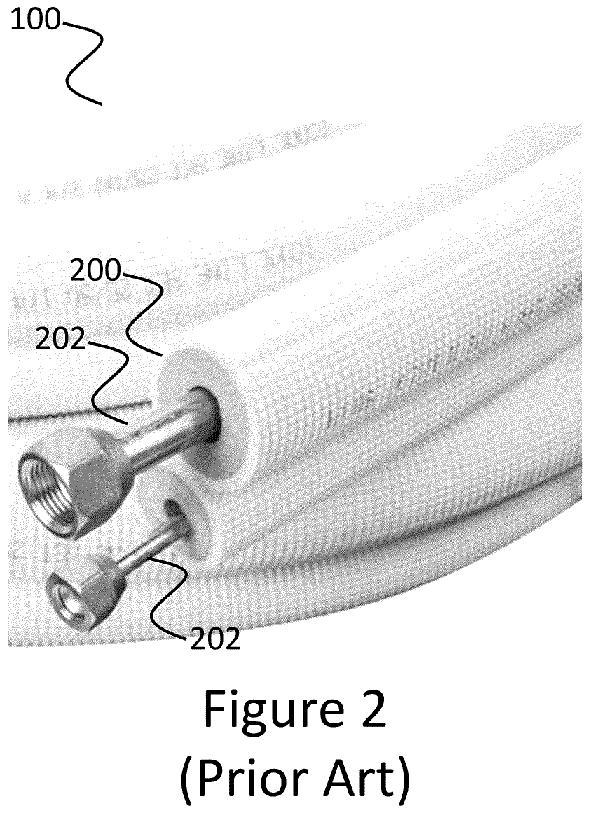

Since the introduction of mini-split inverter systems, the primary point of failure has always been the copper line set 100, such as the one depicted in FIG. 2. The line set 100 is used to convey refrigerant between a compressor, such as that depicted in FIG. 1, and condensing coil, which is located remotely from the compressor, usually indoors. Insulating these line sets 100 improves their efficiency, provides soundproofing, and protects the line set 100 and surrounding structures from moisture buildup due to condensation and other environmental factors. This insulation 200, however, also traps moisture that, over time, finds its way under the insulation 200 and is brought into contact with the line set piping 202.

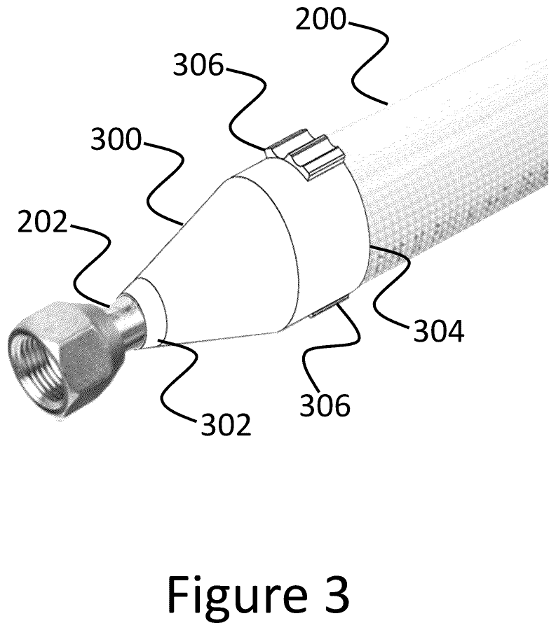

By positioning a line set seal 300, such as the one depicted in FIG. 3, over the piping 202 and insulation 200, moisture intrusion into the line set 100 is eliminated, prolonging the life of the line set 100 and avoiding this common mode of system failure.

More specifically, the present disclosure provides a line set seal 300 that slides over each pipe 202 in a line set 100 and seals insulation 200 disposed on each pipe 202 to the pipe 202 itself. By locking into place over the pipe 202 and insulation 200, the line set seal 300 restricts moisture from entering that space.

As shown in FIG. 3, the line set seal 300 is substantially conical in shape and comprises a pipe sealing end 302, which is relatively small, as well as an insulation sealing end 304, which is relatively larger. The line set seal may be provided in a number of configurations, including different combinations of pipe sealing end 302 and insulation sealing end 304 sizes, to accommodate line sets 100 in common use.

The line set seal 300 may additionally include protrusions 306, which can be configured to allow a user to better grip and twist the line set seal 300 and/or to act as a bumper and/or guide.

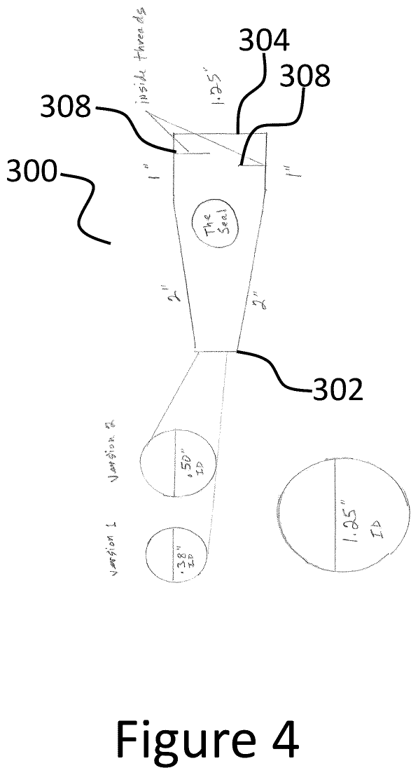

Now referring to FIG. 4, one specific embodiment of the line set seal 300 is disclosed. In this embodiment, the pipe sealing end 302 is sized to have either a 0.38″ or 0.50″ inner diameter (ID) while the insulation sealing end 304 is sized to have an inside diameter of 1.25″. Additionally, the line set seal may further include internal threads 308 configured to pull the line set seal 300 onto insulation 200 when the line set seal 300 is rotated.

In embodiments, the line set seal 300 comprises a substantially cylindrical portion emanating from the insulation sealing end 304 followed by a substantially conical portion that tapers down to a size suitable for sealing a pipe 202 at the pipe sealing end 302.

In embodiments, the substantially cylindrical portion is 1″ long and the substantially conical portion is 2″ long.

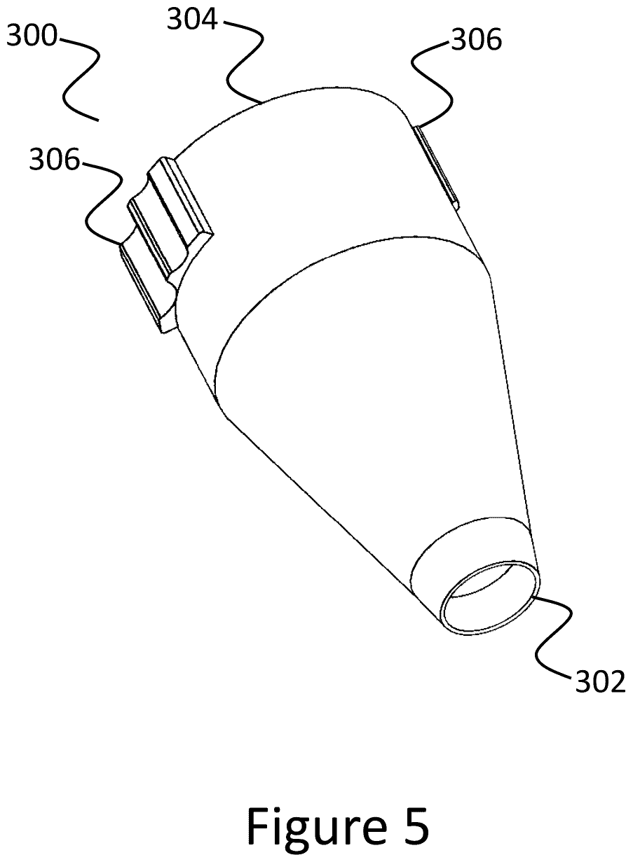

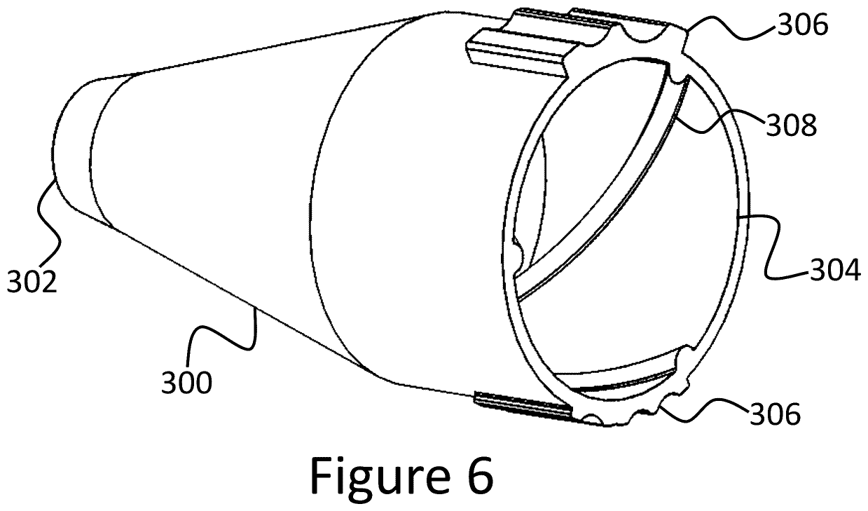

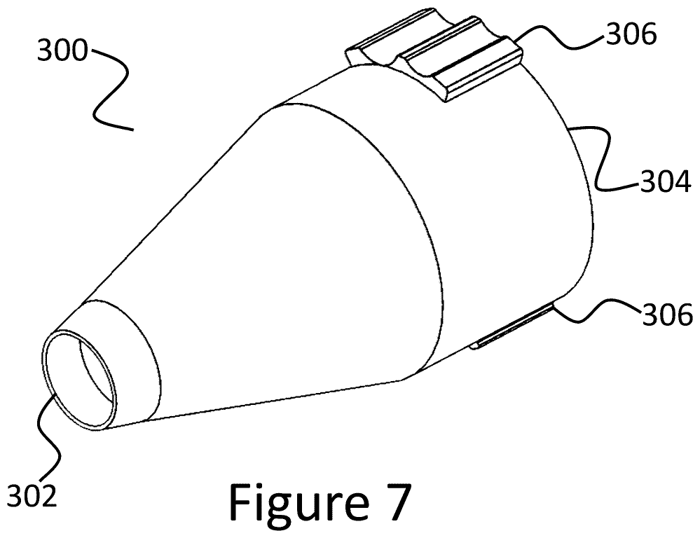

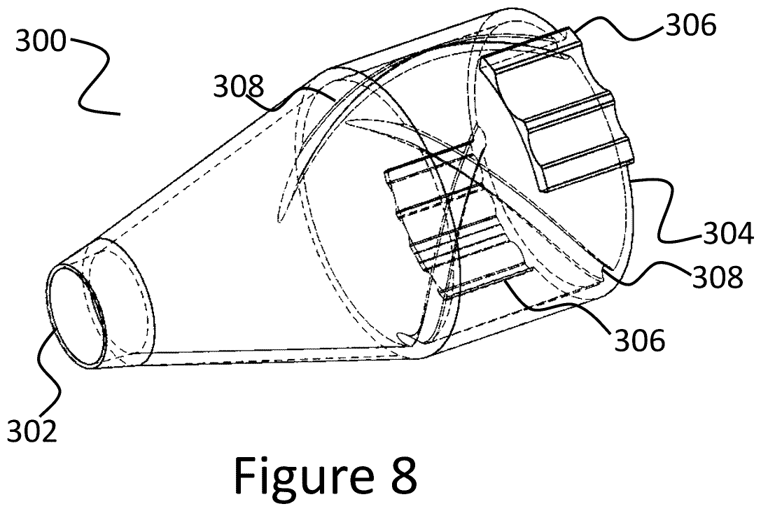

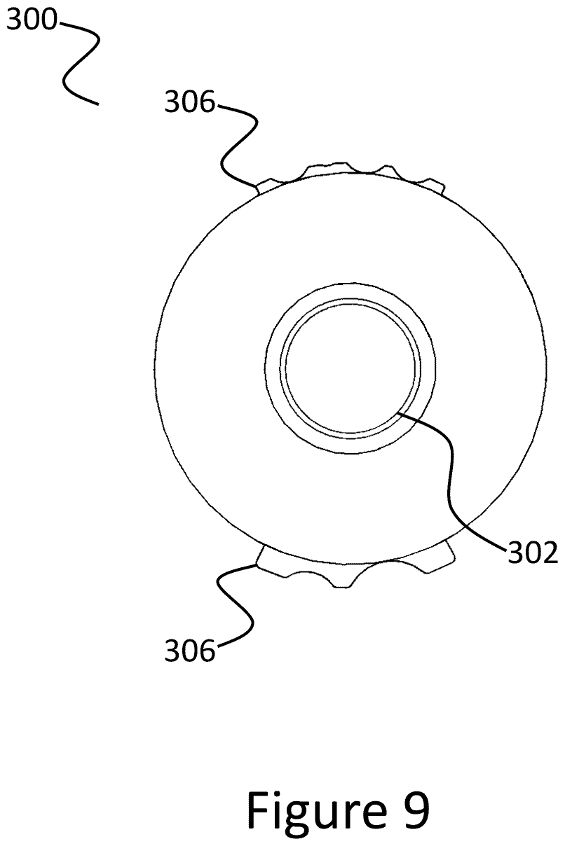

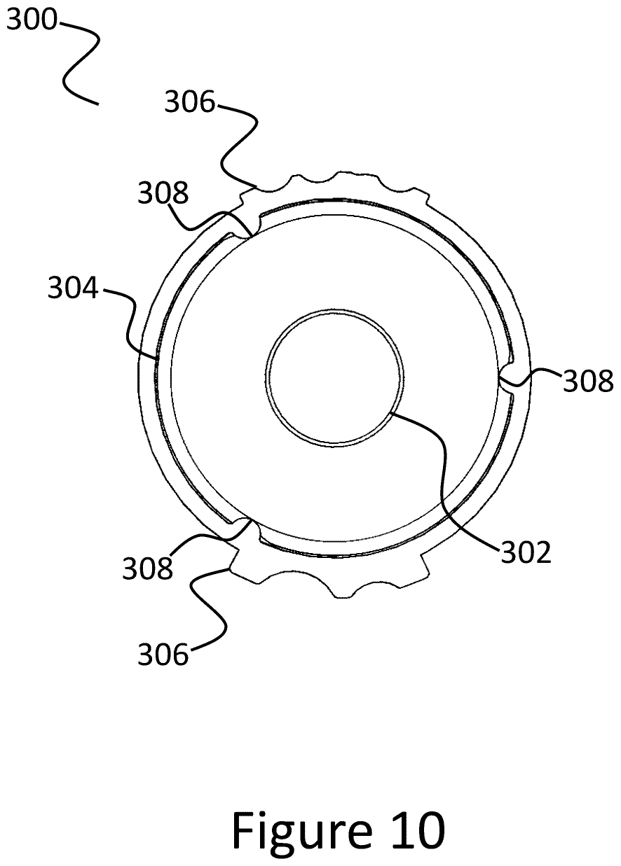

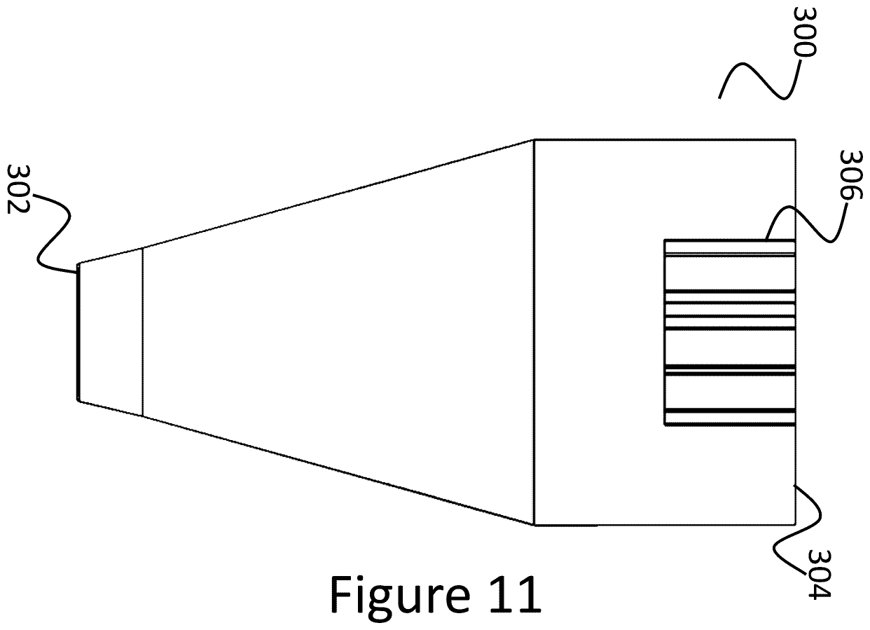

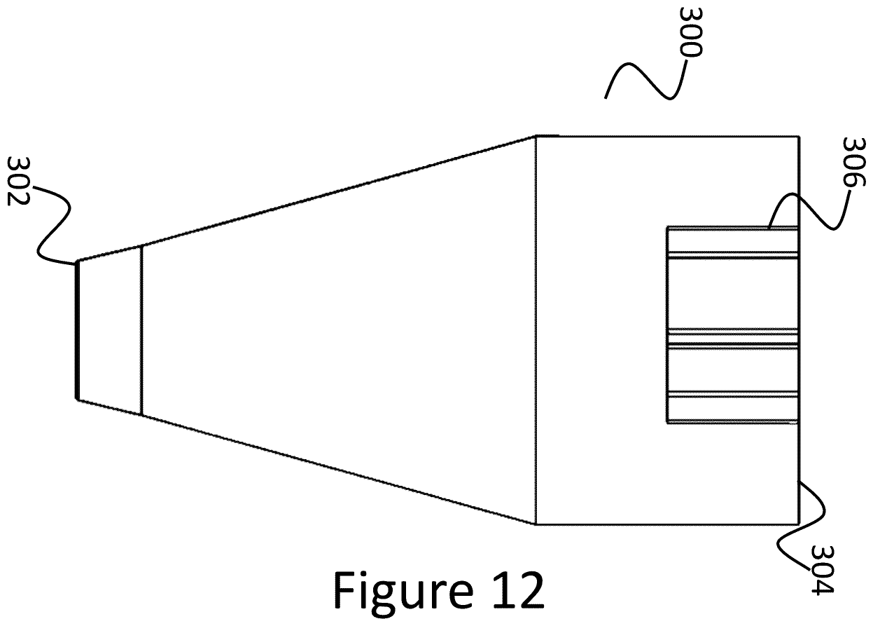

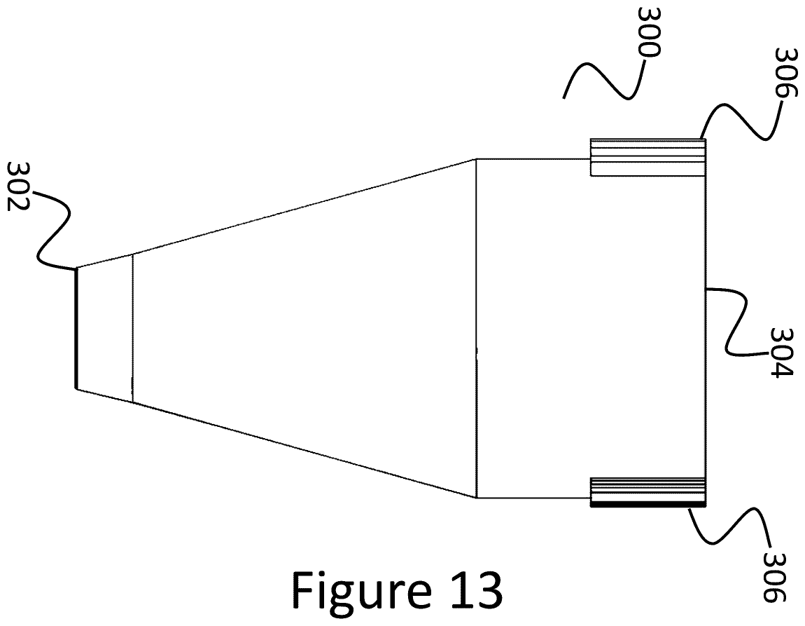

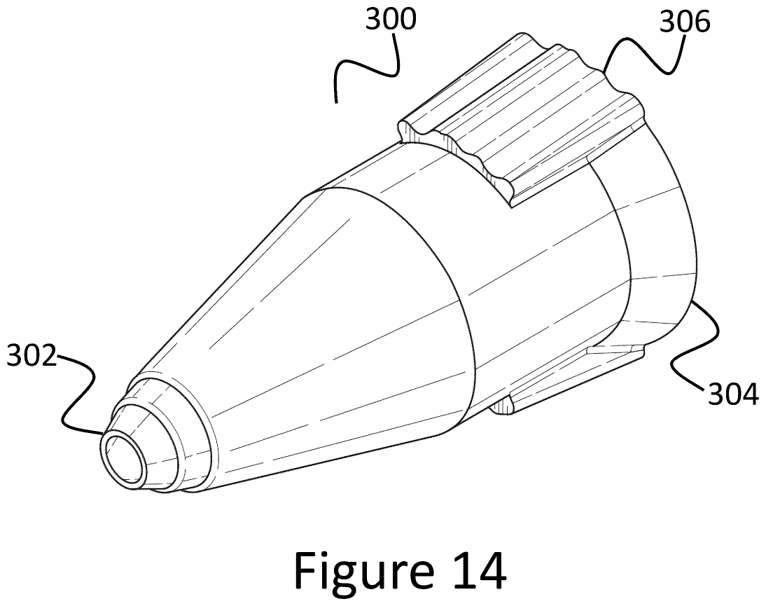

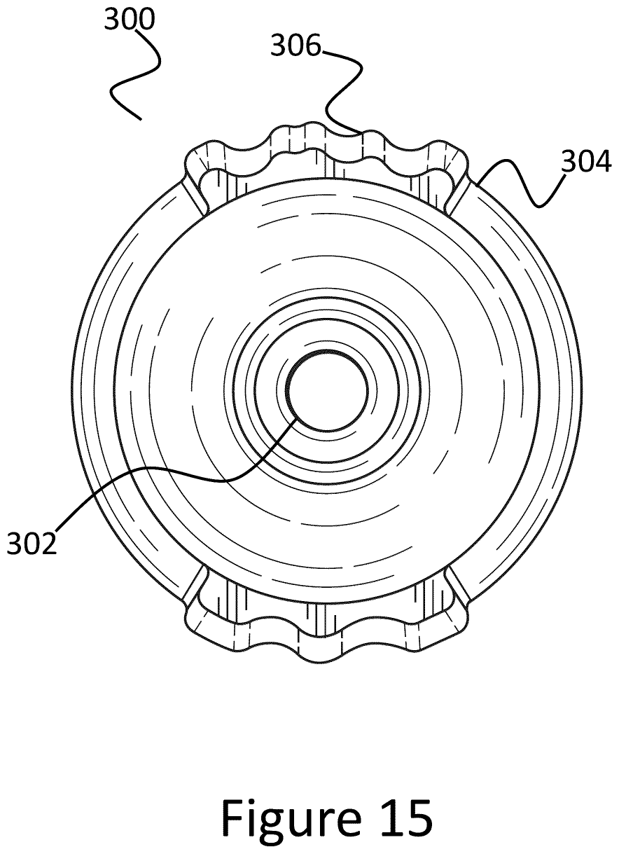

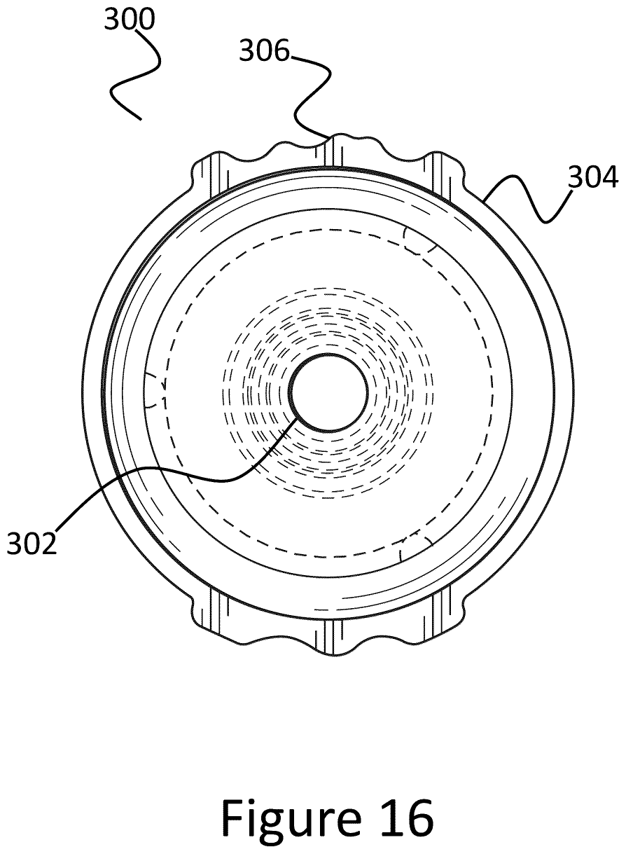

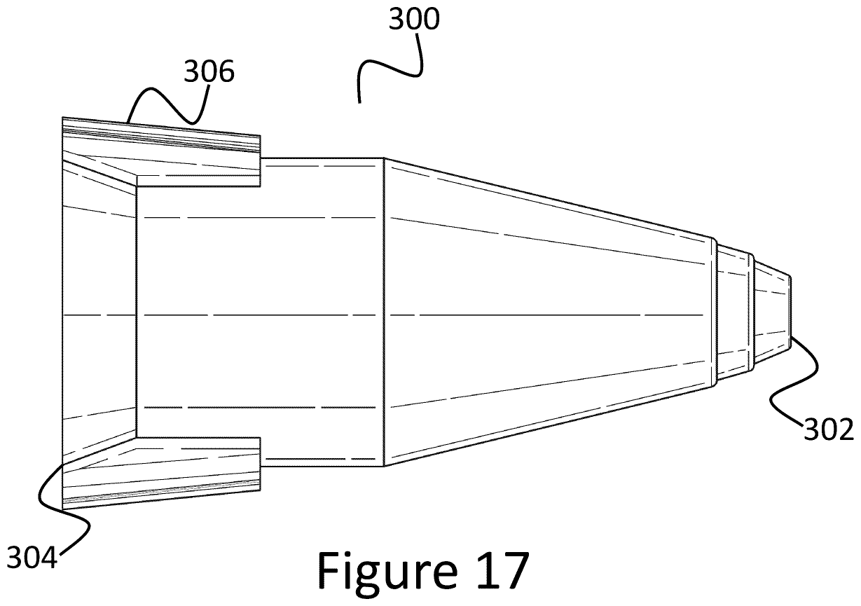

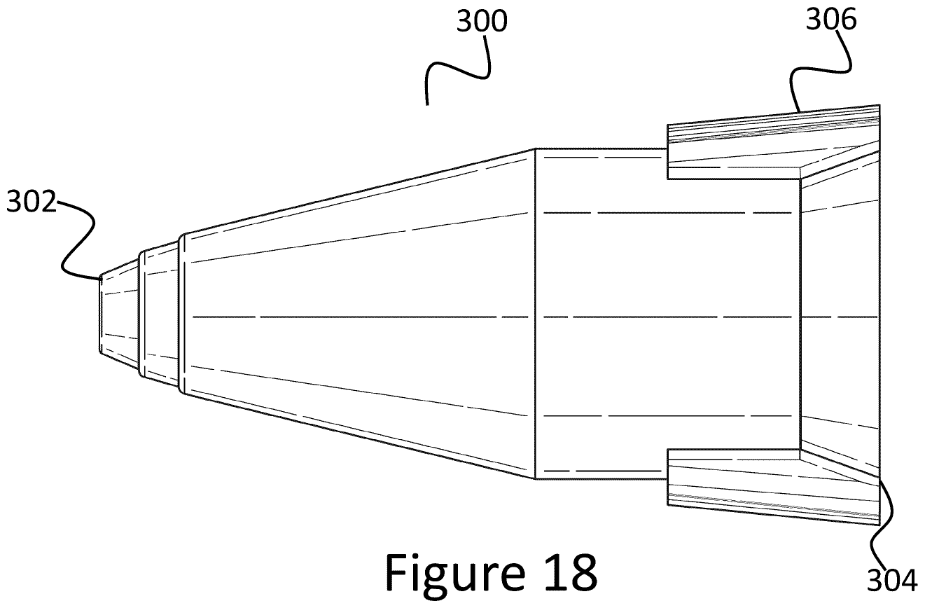

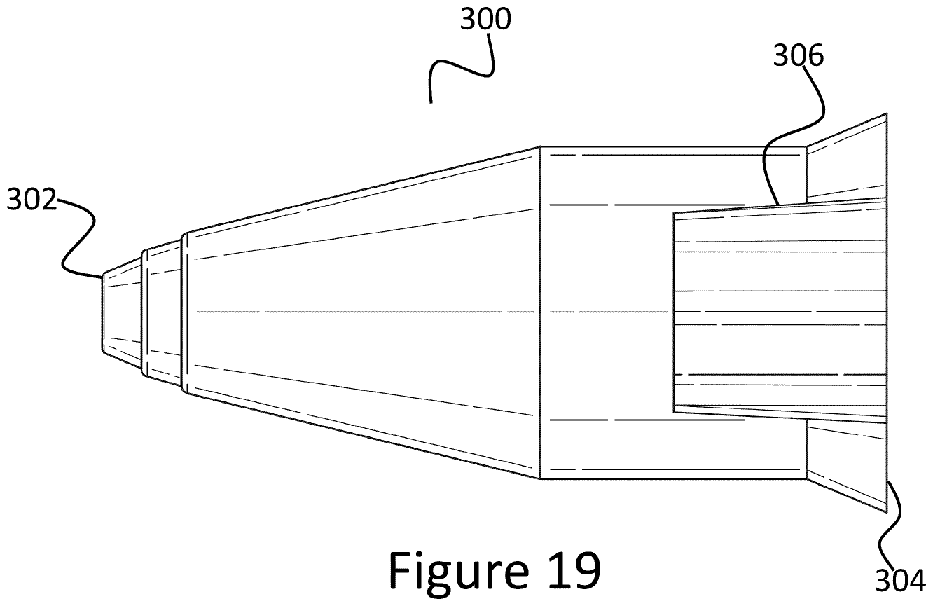

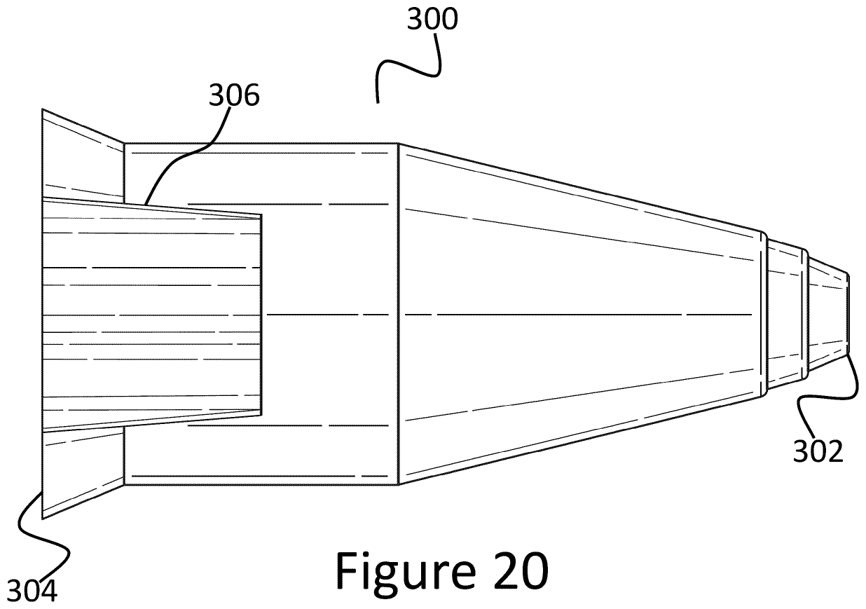

FIGS. 5-20 provide further details and embodiments of the line set seal 300.

In embodiments, the insulation sealing end 304 of the line set seal 300 is flared to allow for easy installation.

In embodiments, the pipe sealing end 302 is stepped, allowing a portion to be removed and the line set seal 300 to be used on line set piping 202 of various diameters.

In embodiments, the pipe sealing end 302 is made of a different material than the remainder of the line set seal 300.

In embodiments, the line set seal comprises a sealing groove configured to retain an O-ring, in embodiments disposed in the pipe sealing end 302 of the line set seal 300.

In embodiments, the line set seal 300 is made in a clamshell or two-part design configured to allow its use on existing installations without disconnecting the line set 100. Such embodiments may employ a zipper lock disposed substantially parallel to a lengthwise orientation of the line set seal 300. A hinge feature may be disposed opposite the zipper lock to allow the clamshell to open more easily. Alternatively, a second zipper lock may be disposed opposite the first zipper lock, allowing the two halves of a two-part design to be joined.

In embodiments, the seal 300 includes substantially flat portions disposed adjacent each end, which are configured to allow the line set seal 300 to be clamped to a line set 100. In embodiments, the substantially flat portions include raised protrusions, with each comprising a central aperture oriented horizontally, relative to the line set seal, allowing a zip tie or clamp to be retained therein and casing installation.

In embodiments, the line set seal 300 comprises a desiccant disposed between the pipe sealing end 302 and insulation sealing end 304. In embodiments, an inner surface of the line set seal 300 is made of a material including a desiccant. In embodiments, the line set seal 300 is made of a waterproof, breathable material, such as Gore-Tex®.

In embodiments, the line set seal comprises a drainage hole disposed between the pipe sealing end 302 and insulation sealing end 304, with the drainage hole being configured to be installed such that it faces downwards, allowing any moisture that may penetrate the line set 100 to escape.

In embodiments, the line set seal 300 comprises a port comprising a hydrophobic filter configured to allow the exchange of air between the inside and outside of the line set seal 300. In embodiments, the line set seal 300 is 3D printed.

In embodiments, the line set seal 300 is cast in place, such as on an existing installation.

In embodiments, the insulation sealing end 304 of the line set seal 300 is formed into the line set 100 insulation 200, creating a unitary structure.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

What is claimed is:

1. A line set seal, the seal comprising:
a pipe sealing end;
an insulation sealing end,
wherein the insulation sealing end is larger than the pipe sealing end,
wherein the pipe sealing end is configured to seal to a pipe, and
wherein the insulation sealing end is configured to seal to insulation.

2. The line set seal of claim 1, further comprising internal threads configured to pull the seal onto insulation upon rotation, wherein the internal threads are disposed adjacent the insulation sealing end.

3. The seal of claim 1, wherein a portion of the seal disposed between the pipe sealing end and insulation sealing end is substantially conical in shape.

4. The seal of claim 1, further comprising at least one protrusion disposed on a periphery of the seal.

5. The seal of claim 4, wherein the at least one protrusion comprises two protrusions disposed opposite one another.

6. The seal of claim 1 wherein the pipe sealing end is sized to have either a 0.38″ or 0.50″ inner diameter and the insulation sealing end is sized to have an inside diameter of 1.25″.

7. The seal of claim 1, wherein the insulation sealing end comprises a substantially cylindrical portion followed by a substantially conical portion that tapers down to a size suitable for sealing a pipe at the pipe sealing end.

8. The seal of claim 1, wherein the pipe sealing end is made of a different material than the remainder of the line set seal.

9. The seal of claim 1, further comprising a sealing groove disposed in the pipe sealing end, the sealing groove being configured to retain an O-ring.

10. The seal of claim 1, wherein the seal is a clamshell design.

11. The seal of claim 10, wherein the seal further comprises a zipper lock disposed substantially parallel to a lengthwise orientation of the seal and a hinge feature disposed opposite the zipper lock.

12. The seal of claim 1, wherein the seal is a two-part design configured to allow its use on existing installations without disconnecting the line set.

13. The seal of claim 12, further comprising at least two zipper locks disposed opposite one another, wherein the zipper locks are configured to allow the two halves of the seal to be joined together to form a watertight seal.

14. The seal of claim 1, wherein the pipe sealing end and insulation sealing end each comprise substantially flat, outer portions that are configured to accommodate a clamp and allow the seal to be clamped to a line set.

15. The seal of claim 14, wherein the substantially flat portions comprise raised protrusions distributed about a periphery thereof, with each protrusion comprising a central aperture oriented horizontally, relative to the line set seal.

16. The seal of claim 1, further comprising a desiccant disposed between the pipe sealing end and insulation sealing end.

17. The seal of claim 1, further comprising an aperture disposed in an inner wall of the seal between the pipe sealing end and insulation sealing end, wherein the aperture is configured to allow moisture trapped within the seal to drain therefrom.

18. The seal of claim 1, further comprising a port comprising a hydrophobic filter configured to allow the exchange of air between an inside of the seal and an external environment of the seal.

19. A line set, the line set comprising:
a first pipe;
a second pipe fixed to the first pipe;
insulation disposed along a length of each of the first pipe and the second pipe; and
a line set seal, the seal comprising:
a pipe sealing end;
an insulation sealing end,
wherein the insulation sealing end is larger than the pipe sealing end,
wherein the pipe sealing end is configured to seal to a pipe, and
wherein the insulation sealing end is configured to seal to insulation,
wherein the line set seal is disposed over a terminal end of the insulation disposed over each pipe, covering an interface between the insulation and each pipe.

20. A line set seal, the seal comprising:
a pipe sealing end;
an insulation sealing end comprising internal threads configured to pull the seal onto insulation upon rotation;
two protrusions disposed opposite one another about a periphery of the insulation sealing end,
wherein the insulation sealing end comprises a substantially cylindrical portion followed by a substantially conical portion that tapers down to a size suitable for sealing a pipe at the pipe sealing end,
wherein the pipe sealing end is configured to seal to a pipe, and
wherein the insulation sealing end is configured to seal to insulation.
